(19) United States
(12) Patent Application Publication
(10) Pub. No.: US 2021/0302800 A1
(43) Pub. Date: Sep. 30, 2021

(54) OPTICAL ELEMENT AND ELECTRONIC APPARATUS

(71) Applicant: Sony Corporation, Tokyo (JP)

(72) Inventors: Koji KADONO, Tokyo (JP); Shinji IMAIZUMI, Tokyo (JP)

(21) Appl. No.: 17/266,698

(22) PCT Filed: Jul. 29, 2019
(86) PCT No.: PCT/JP2019/029578

§ 371 Date: Feb. 8, 2021

(30) Foreign Application Priority Data
Aug. 8, 2018 (JP) 2018-149522

(51) Int. Cl. G02F 1/17; G02F 1/01; G02F 1/21

(52) U.S. Cl. CPC G02F 1/17; G02F 1/0128; G02F 1/217; G02F 2203/58; G02F 2202/16; G02F 2202/36; G02F 2201/16

(57) ABSTRACT

[Object] To provide an optical element and an electronic apparatus having a high response speed and high controllability of a modulation wavelength.

[Solving Means] An optical element according to the present technology includes a first conductor film, a second conductor film, and a dielectric film. The first conductor film has light transmittance and capable of controlling optical transition energy by a Fermi level adjustment. The second conductor film has the light transmittance and capable of controlling the optical transition energy by the Fermi level adjustment. The dielectric film is arranged between the first conductor film and the second conductor film and has the light transmittance and elasticity.

### TECHNICAL FIELD

The present technology relates to an optical element and an electronic apparatus for performing light modulation by an optical interference effect.

### BACKGROUND ART

As an element for modulating light, there are mainly a Mach-Zehnder type element, an EO (Electro Optical) element and the like, which is difficult to miniaturize. On the other hand, a Fabry-Perot type element using optical interference is an optical element that reflects only a specific wavelength, and used as a filter for reflecting or transmitting only the specific wavelength by controlling an interference optical path length (hereinafter referred to as Fabry-Perot filter).

In recent years, it has become possible to modulate reflection characteristics (for example, see Non-Patent Literature 1) by electrically changing optical characteristics using graphene at a reflection interface (for example, see Patent Literature 1). However, the Fabry-Perot filter has a structure that extracts only light of the specific wavelength corresponding to an optical path length designed in advance, and the wavelength itself is fixed and cannot be arbitrarily changed.

Here, there has been recently proposed a method of electrically controlling a displacement of a film defining an optical path on a nano-scale order (for example, see Non-Patent Literature 2). This allows graphene, which is a light absorbing conductor film, to be suspended in a hollow space and a voltage to be applied to the conductor film to produce an electrostatic attraction, whereby controlling the displacement of the conductor film and varying the interference optical path length of light propagating inside an element.

Thus, it is said that the wavelength of interfering light can be controlled even though the filter is a Fabry-Perot filter, and by applying a high voltage such as 150V, a peak wavelength of a spectrum of the light propagating inside the element and reflected can be shifted in a range of about 5 nm to 20 nm.

### CITATION LIST

### Patent Literature

Patent Literature 1: Japanese Patent Application Laid-open No. 2013-257482

### Non-Patent Literature

Non-Patent Literature 1: Francisco J. Rodriguez, four others, “Solid-State Electrolyte-Gated Graphene in Optical Modulators,” ADVANCED MATERIALS 2017, 1606372
Non-Patent Literature 2: P. A. Thomas, seven others, “Nanomechanical electro-optical modulator based on atomic heterostructures”, Nature Communications, DOI: 10.1038 per ncomms13590

### DISCLOSURE OF INVENTION

### Technical Problem

However, although the conductive film such as graphene, which is an atomic layer thin film, is a material having a certain mechanical strength and flexibility, it is extremely difficult to stably suspend it in a hollow state only by contacting a peripheral portion with a metal inside the element.

In addition, a relative dielectric constant of air itself is 1, in order to generate the electrostatic attraction, it needs to apply a very large voltage, and large-sized peripheral circuits and a large power consumption are necessary. Furthermore, when the hollow state is formed, a variation becomes large, and it is extremely difficult to control a target wavelength in the order of nm.

Furthermore, since a refractive index difference between graphene and an air layer is increased, there is also a problem that a significant loss occurs in interference light extracted due to an interfacial reflection. In addition, since the thin film is mechanically operated in the hollow state, resonance or the like is generated, by which an operation delay or the like is generated such that a linear response to an input is impossible.

In view of the above circumstances, an object of the present technology is to provide an optical element and an electronic apparatus having a high response speed and a high controllability of a modulation wavelength.

### Solution to Problem

To achieve the above object, an optical element according to the present technology includes a first conductor film, a second conductor film, and a dielectric film.

The first conductor film has light transmittance and capable of controlling optical transition energy by a Fermi level adjustment.

The second conductor film has the light transmittance and capable of controlling the optical transition energy by the Fermi level adjustment.

The dielectric film is arranged between the first conductor film and the second conductor film and has the light transmittance and elasticity.

According to this structure, the first conductor film and the second conductor film can vary a light absorption amount of a specific wavelength (modulation wavelength) by controlling the optical transition energy with the Fermi level adjustment (adjustment of charge concentration, etc.). In addition, an electrostatic attraction force is generated between the first conductor film and the second conductor film by a potential difference between the first conductor film and the second conductor film, and the dielectric film is elastically deformed. As a result, a film distance between the first conductor film and the second conductor film changes, and it becomes possible to change the modulation wavelength.

The dielectric film may be formed of a material having a relative dielectric constant of 1.8 or more and 100 or less and a tensile modulus of 3000 MPa or less.

The dielectric film may be formed of a material having a tensile modulus of 10 MPa or more and 900 MPa or less.

The dielectric film may be formed of a material having a tensile modulus of elasticity of 200 MPa or less.

The dielectric film may be formed of a material having an elongation value of 100% or more and 800% or less by an elongation test prescribed in the ASTM D638 standard.

The optical element according to claim 1, in which the dielectric film may be formed of a material having a compressive strength value of 500 kg/cm² or more by a compressive strength test prescribed in the ASTM D695 standard.

The dielectric film may be formed of an elastomer, rubber, low density polyethylene, tetrafluoroethylene, silicone, cellulose acetate or an ethylene-vinyl acetate copolymer.

The dielectric film may have a thickness of 100 nm or more and 10 mm or less.

The first conductor film and the second conductor film may each have a light absorption coefficient that changes by increasing or decreasing a carrier concentration.

The first conductor film and the second conductor film may have elasticity.

Each of the first conductor film and the second conductor film may be formed of graphite, carbon nanotube, nanographite, fullerenes, a carbon fiber, or a carbon black.

The optical element may further include a light reflection film having a light reflectivity arranged on a side opposite to the dielectric film of the first conductor film.

The light reflection film may have elasticity. The optical element.

The light reflection film may be formed of gold, silver, copper, aluminum, nickel or a titanium compound.

The first conductor film and the second conductor film are connected to a power source for applying a potential difference between the first conductor film and the second conductor film.

When the potential difference is applied between the first conductor film and the second conductor film, the dielectric film may be pressed from the first conductor film and the second conductor film by an electrostatic attraction force generated between the first conductor film and the second conductor film to cause elastic deformation so that a film thickness is changed.

In order to achieve the above object, an optical element according to the present technology includes an optical element. The optical element includes a first conductor film having light transmittance and capable of controlling optical transition energy by a Fermi level adjustment, a second conductor film having the light transmittance and capable of controlling the optical transition energy by the Fermi level adjustment, and a dielectric film arranged between the first conductor film and the second conductor film and having light transmittance and elasticity.

### Advantageous Effects of Invention

As described above, according to the present technology, it is possible to provide an optical element and an electronic apparatus having the high response speed and high controllability of the modulation wavelength. Note that effects described here are not necessarily limitative, and any of the effects described in the present disclosure may be provided.

### BRIEF DESCRIPTION OF DRAWINGS

FIG. 1 is a cross-sectional view of an optical element according to an embodiment of the present technology.

FIG. 2 is a schematic diagram showing an operation of the optical element.

FIG. 3 is a graph showing a time response (75 V) of a reflectance of the optical element according to an example of the present technology.

FIG. 4 is a graph showing the time response (55 V) of the reflectance of the optical element according to the example of the present technology.

### MODE(S) FOR CARRYING OUT THE INVENTION

An optical element according to an embodiment of the present technology will be described.

[Structure of the Optical Element]

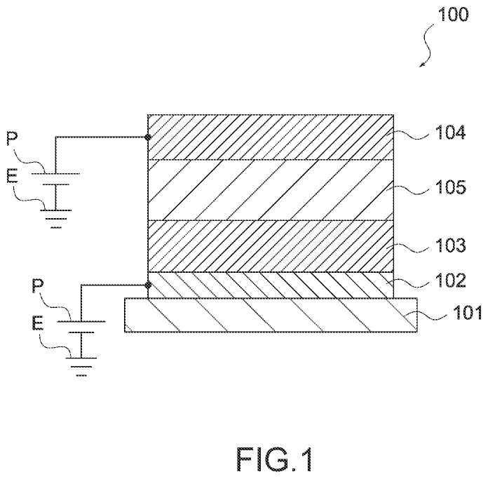

FIG. 1 is a cross-sectional view showing the structure of the optical element 100 according to an embodiment of the present technology.

As shown in FIG. 1, the optical element 100 includes a base material 101, a light reflection film 102, a first conductor film 103, a second conductor film 104, and a dielectric film 105.

The base material 101 supports each layer of the optical element 100. The base material 101 desirably has elasticity and a smooth surface, and may be formed of, for example, polycarbonate, polyethylene terephthalate, or the like.

The light reflection film 102 reflects light incident from a first conductor film 103 side. The light reflection film 102 is arranged on the base material 101 at a side opposite to the dielectric film 105 of the first conductor film 103, and is abutting against the first conductor film 103. The light reflection film 102 desirably has a metal surface having a high light reflectance and has the elasticity. Examples of the material of the light reflection film 102 include gold, silver, copper, aluminum, nickel, a titanium compound, and the like. A thickness of the light reflection film 102 is not particularly limited, but may be, for example, 100 nm.

The first conductive film 103 is a conductive thin film having light transmittance arranged on the light reflection film 102, and is a thin film capable of controlling optical transition energy by the Fermi level adjustment, in other words, is a thin film whose optical characteristics are changed by adjusting a carrier concentration.

Specifically, the first conductor film 103 can be a conductor film having a light absorption coefficient that changes by increasing or decreasing the carrier concentration. Furthermore, the first conductor film 103 desirably has the elasticity.

Examples of the material of the first conductor film 103 include graphite, a carbon nanotube, nanographite, fullerenes, a carbon fiber, and a carbon black. A thickness of the first conductor film 103 is not particularly limited, but may be, for example, 10 nm.

The second conductor film 104 is a conductor thin film having light transmittance arranged on the dielectric film 105 and is a thin film capable of controlling the optical transition energy by the Fermi level adjustment, in other words, is a thin film whose optical characteristics are changed by adjusting the carrier concentration.

Specifically, the second conductor film 104 can be a conductor film having the light absorption coefficient that changes by increasing or decreasing the carrier concentration. In addition, the second conductor film 104 desirably has the elasticity.

Examples of the material of such a second conductor film 104 include graphite, a carbon nanotube, nanographite, fullerenes, a carbon fiber, and a carbon black.

Incidentally, the material of the second conductor film 104 and the material of the first conductor film 103 may be the same, or may be different. A thickness of the second conductor film 104 is not particularly limited, but may be, for example, 10 nm.

The dielectric film 105 is arranged between the first conductor film 103 and the second conductor film 104, and has the light transmittance and the elasticity. The dielectric film 105 is desirably formed of a material having a high relative dielectric constant and a small tensile elastic modulus, and specifically, can be formed of a material having a relative dielectric constant of 1.8 or more and 100 or less and a tensile elastic modulus of 3000 MPa or less. Incidentally, a numerical range that the relative dielectric constant is 100 or less is obtained from an upper limit value of a material called as ferroelectric elastic crystal.

Such a material can include polystyrene, polyacetal and other polymeric-based materials.

In addition, the dielectric film 105 desirably has a lower tensile elastic modulus, and specifically, can be formed of a material having a tensile elastic modulus of 10 MPa or more and 900 MPa or less. Incidentally, a numerical range that the tensile modulus is 10 MPa or more and 900 MPa or less corresponds to the range of the tensile modulus of the elastomer.

Such a material include low density polyethylene, tetrafluoroethylene, silicone, cellulose acetate or an ethylene-vinyl acetate copolymer, in addition to a common elastomeric material and a common rubber material.

In addition, the dielectric film 105 may have a still smaller tensile elastic modulus, and specifically, may be formed of a material having a tensile elasticity of 200 MPa or less.

Such a material may include an elastomer such as silicone. Note that a value of each tensile modulus described above is obtained at room temperature (25° C.).

In addition, the material of the dielectric film 105 may be a material having high tensile properties. Specifically, the dielectric film 105 is desirably formed of a material having a relative dielectric constant of 1.8 or more and 100 or less and an elongation value of 100% or more and 800% or less according to an elongation test prescribed in the ASTM D638 standard. Note that a numerical range that the elongation value is 100% or more and 800% or less corresponds to a range of an elongation value of the elastomer.

In addition, the material of the dielectric film 105 may be a material having a high compressive strength. Specifically, the dielectric film 105 is desirably formed of a material having a relative dielectric constant of 1.8 or more and 100 or less and a compressive strength value of 500 kg/cm² or more according to a compressive strength test prescribed in the ASTM D695 standard.

Furthermore, the material of the dielectric film 105 may be a material having a large solubility parameter and a large dielectric tangent. Specifically, the dielectric film 105 is desirably formed of a material having the relative dielectric constant of 1.8 or more and 100 or less, the solubility parameter of 10 MPa′¹² or more, and the dielectric tangent of greater than 0.0002 in a frequency band of 100 MHz or more and 10 GHz or less.

Such a material include ABS (acrylonitrile-butadiene-styrene copolymer resin), HDPE (high-density polyethylene), PVC (polyvinyl chloride), kaptone, nylon, Teflon™ such as PTFE (polytetrafluoroethylene), polymer materials such as silicone, polyamide, polycarbonate, polypropylene and polystyrene, and dielectric elastomer materials such as butyl rubber, neoprene rubber, gutta-percha, and an acrylic ester.

A thickness of the dielectric film 105 is desirably 100 nm or more and 10 mm or less. A modulation wavelength of the optical element 100 changes depending on an amount of strain of the dielectric film 105, but the amount of strain depends on an applied voltage and an electric field determined by the thickness of the dielectric film 105. When the thickness of the dielectric film 105 is to be 100 nm or more and 10 nm or less, an area distortion of 0.1 to 10% is generated in the dielectric film 105, and a control of the modulation wavelength becomes possible from a visible light wavelength (>300 nm) to a far infrared wavelength (to 20000 nm).

[Electrical Connection]

As shown in FIG. 1, the light reflection film 102 and the second conductor film 104 are connected to a power source P, and the power source P is connected to a ground E.

Thus, in the optical element 100, it is configured to be capable of applying a predetermined potential difference between the first conductor film 103 and the second conductor film 104.

Incidentally, the optical element 100 may have any configuration capable of applying the predetermined potential difference between the first conductor film 103 and the second conductor film 104, and both the first conductor film 103 and the light reflection film 102 may not be connected to the power supply P and the ground E.

For example, the second conductor film 104 may be connected to the ground, and the light reflection film 102 may be connected to the power source that produces the predetermined potential difference with respect to the ground. Furthermore, the light reflection film 102 may be connected to the ground, the second conductor film 104 may be connected to the power source that produces the predetermined potential difference with respect to the ground. In addition, one of the second conductor film 104 or the light reflection film 102 may form a floating electrode.

Note that although wiring is directly connected to the second conductor film 104 in FIG. 1, an electrode formed of a conductive material may be provided on the second conductor film 104, and the wiring and the second conductor film 104 may be electrically connected to each other via the electrode.

[Operation of Optical Element]

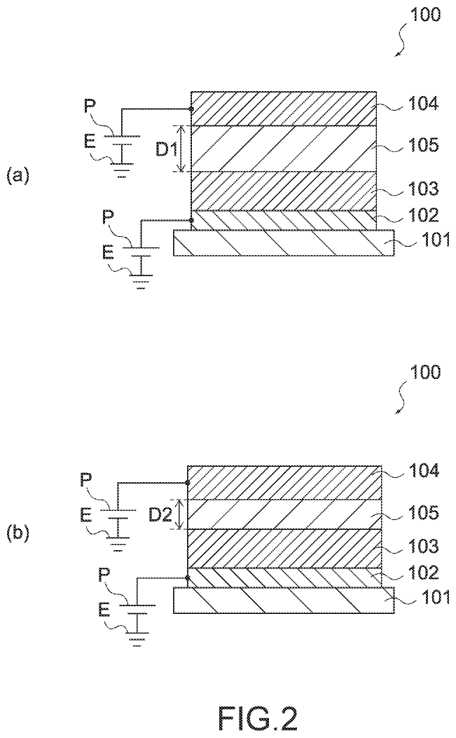

An operation of the optical element 100 will be described. FIG. 2 is a schematic diagram showing the operation of the optical element 100.

FIG. 2(a) shows a state in which no potential difference is applied between the first conductor film 103 and the second conductor film 104. The thickness of the dielectric film 105 in this state is shown as a thickness D1. In this state, when light is made incident on the optical element 100 from a second conductive film 104 side (upper side in figure), the light passes through the second conductive film 104, the dielectric film 105, and the first conductive film 103, and is reflected by the light reflection film 102.

Here, incident light to the optical element 100 and reflection light reflected by the light reflection film 102 cause interference, and a component of a specific wavelength is absorbed.

That is, light modulation is performed by an optical interference effect.

FIG. 2(b) shows a state in which the potential difference is applied between the first conductor film 103 and the second conductor film 104. When the potential difference is applied between the first conductor film 103 and the second conductor film 104, the carrier concentration is changed in the first conductor film 103 and the second conductor film 104.

The first conductive film 103 and the second conductive film 104 are thin films capable of controlling the optical transition energy by the Fermi level adjustment, and the light absorption coefficient changes by a change in the carrier concentration, so that a light absorptance rate is varied by applying the potential difference.

Furthermore, by applying the potential difference between the first conductor film 103 and the second conductor film 104, the electrostatic attraction force is generated between the first conductor film 103 and the second conductor film 104, and the dielectric film 105 is pressed from the first conductor film 103 and the second conductor film 104.

Since the dielectric film 105 is formed of an elastic body, the elastic deformation is caused by being pressed from the first conductor film 103 and the second conductor film 104, the thickness of the dielectric film 105 is reduced from the thickness D1 to a thickness D2. Incidentally, although an actual change in the thickness is small, the change is emphasized in FIG. 2. As a result, a film distance between the first conductor film 103 and the second conductor film 104 decreases, and the interference optical path length changes, so that the wavelength of light modulated by the optical interference effect is varied.

When eliminating the potential difference between the first conductor film 103 and the second conductor film 104, the electrostatic attraction force between the first conductor film 103 and the second conductor film 104 disappears, the second conductor film 104 returns to its original thickness.

Thus, in the optical element 100, in addition to the variation in the light absorptance rate due to the change in the carrier concentration of the first conductive film 103 and the second conductive film 104, a wavelength variation of the modulated light due to the change in the thickness of the dielectric film 105 occurs. Therefore, it is possible to arbitrarily control the wavelength of the modulated light by the potential difference applied between the first conductor film 103 and the second conductor film 104.

Note that when the dielectric film 105 is elastically deformed, and the first conductor film 103 and the second conductor film 104 adjacent to the dielectric film 105 are hardly deformed, the dielectric film 105 may be prevented from being elastically deformed, or the first conductor film 103 and the second conductor film 104 may be damaged.

Therefore, it is desirable that the first conductive film 103 and the second conductive film 104 have the elasticity and deform following the elastic deformation of the dielectric film 105. In addition, it is desirable that the light reflection film 102 and the base material 101 also have the elasticity.

[Method of Manufacturing Optical Element]

Although there is no particular limitation on a method of manufacturing the optical element 100, it is possible to manufacture the optical element 100 as follows, for example.

A metal mask pattern is arranged to form an extracting terminal on the base material 101. Subsequently, a light reflection film 102 (lower extracting terminal) is formed on the masked base material 101. The light reflection film 102 can be formed by vapor-depositing a metal.

Subsequently, the first conductor film 103 is formed on the light reflection film 102. The first conductor film 103 can be formed by transferring a sheet-like conductive material.

Subsequently, the dielectric film 105 is formed on the light reflection film 102. The dielectric film 105 may be formed by spray-coating a dielectric material. The thickness of the dielectric film 105 can be controlled by the time of spray coating.

Next, the second conductor film 104 is formed on the dielectric film 105. The second conductor film 104 can be formed by transferring the sheet-like conductive material.

Next, a metal mask having a predetermined opening is arranged on the second conductor film 104, and an upper extracting terminal (not shown) is formed using the metal mask. The extracting terminal can be formed by depositing a metal.

Subsequently, the light reflection film 102 (lower extraction terminal) and the upper extraction terminal are connected to the power source. This connection can be made by bonding an anisotropic conductive film with a pressure.

The optical element 100 can be manufactured as described above.

[Effects of Optical Element]

As described above, in the optical element 100, since the wavelength of the modulated light can be arbitrarily controlled and the interference optical path length can be controlled by the potential difference applied between the first conductor film 103 and the second conductor film 104, the wavelength of the modulated light can be controlled in the order of nm.

In addition, in the structure in which graphene is suspended in a hollow space (herein after referred to as hollow state) as described in Non-Patent Literature 2, it needs to adjust the potential corresponding to a displacement amount of graphene, but the optical element 100 can be driven at a constant voltage.

Furthermore, since the optical element 100 can be manufactured by laminating layers without need to provide the hollow structure, it is possible to manufacture at a high yield.

Furthermore, although a large tolerance may occur due to deflection or the like of graphene in the hollow structure, there is no cause of such tolerance in the optical element 100, and it is possible to realize a light modulator having a small tolerance.

In addition, in the hollow structure, there is an interface between air and graphene having a large refractive index difference, and a loss of an amount of light due to the interfacial reflection occurs, but in the optical element 100, there is no interface with air, and it is possible to suppress the loss of the amount of light due to the interfacial reflection.

In addition, since the dielectric film 105 is the elastic body and returns to its original thickness when the potential difference between the first conductor film 103 and the second conductor film 104 disappears, the optical element 100 can repeatedly perform a light modulation operation with high reproducibility.

Furthermore, while a high modulation frequency prevents the hollow structure from following a displacement of graphene, the optical element 100 allows a linear response operation at a high modulation frequency because the dielectric film 105 undergoes a rapid elastic deformation.

[Fermi Level Adjustment]

The above-described optical element 100 controls the charge concentration of the first conductor film 103 and the second conductor film 104 by applying the potential difference between the first conductor film 103 and the second conductor film 104, and changes the optical characteristics. Alternatively, the optical characteristics may be changed by a method other than the application of the potential difference.

The first conductive film 103 and the second conductive film 104 may be those capable of controlling the optical transition energy by the Fermi level adjustment, and can also be those, for example, controlling the charge concentration of the first conductive film 103 and the second conductive film 104 by an external field such as light to change the optical characteristics.

[Electronic Apparatus]

The optical element 100 according to the present embodiment can be used as an optical modulation element for controlling light absorption in a desired wavelength range as described above. Moreover, various types of electronic apparatuses can be realized by using the structure of the optical element 100.

For example, the optical element 100 may realize a reflective display or a wavelength selective mirror that controls the amount of reflection light in the specific wavelength range. Furthermore, by the optical element 100, it is possible to realize a wavelength selective filter or a transmitted light type display for controlling an amount of transmitted light in the specific wavelength range.

Furthermore, the optical element 100 may realize a light detecting element that allows light detection in the specific wavelength range. A target light modulation range or a target light detection band in the electronic apparatus can optionally determine the modulation wavelength, a detection wavelength, and a half width between the visible light range and the far infrared light range (300 to 20000 nm) by a material selection and a structural design in each layer structure.

### Example

An optical element according to an example was produced as follows:

On a base material mainly formed of polyethylene terephthalate, which was a smooth elastic body, a metal mask pattern for forming an extracting terminal was arranged, and metal silver was deposited on the masked base material by vapor deposition to form a light reflection film (lower extracting terminal). A thickness of the light reflection film was about 100 nm.

Multilayer graphene was transferred onto the light reflection film to form a first conductor film. Transfer was performed by peeling off highly oriented pyrolytic graphite using a heat peeling type adhesive sheet, adhering it to the light reflection film, and peeling off the adhesive sheet with heat applied to the base material at 70° C. The transferred multilayer graphene had a 30-layer structure and a film thickness was 10 nm.

Subsequently, an acrylic acid ester having a viscosity of 50 mPaS was spray-coated on the first conductor film to form a dielectric film. In addition to the acrylic ester, dielectric films were also formed with low viscosity PVC (polyvinyl chloride), silicone, or polyimide. A film thickness of each of these films can be controlled by the time of the spray code, and the film formation was performed with different film thicknesses in a range from 1 μm to 20 μm.

Subsequently, the multilayer graphene was transferred onto the dielectric film to form a second conductive film. Transfer was performed by peeling off the highly oriented pyrolytic graphite using the heat peeling type adhesive sheet, adhering it to the dielectric film, and peeling off the adhesive sheet with heat applied to the base material at 70° C. The transferred multilayer graphene had the 30-layer structure and the film thickness was 10 nm.

Subsequently, a metal mask including a constant opening was arranged on the second conductor film, metal silver having a thickness of 50 nm was vapor-deposited using the metal mask, and the upper extraction terminal was formed.

An anisotropic conductive film was bonded to the light reflection film (lower extraction terminal) and the upper extraction terminal with a pressure, and connected to a power supply via a flexible printed circuit board. As described above, the optical element according to the example was produced.

Measurements of reflection spectra were carried out on the produced optical element. At frequencies of 1 Hz, 1 kHz, and 1 MHz, a sine wave of 75 V was applied at peak-to-peak, while at the same time, infrared light of 1500 nm to 2500 nm was incident at an angle of 15° from just above.

Spectrophotometric measurements of the reflection spectra confirmed that the reflection spectra were modulated in any of the frequency bands. Furthermore, it was confirmed that the peak wavelength of the modulating reflection spectrum was shifted when the applied voltage was changed.

Next, a change in the reflectance was measured for the produced optical element. The sine waves of 75 V and 0 V were applied to the optical element at a frequency of 1 kHz, and laser light was irradiated by using a semiconductor laser FPL1059S (oscillation wavelength of 1650 nm, manufactured by Thorlabs Corporation).

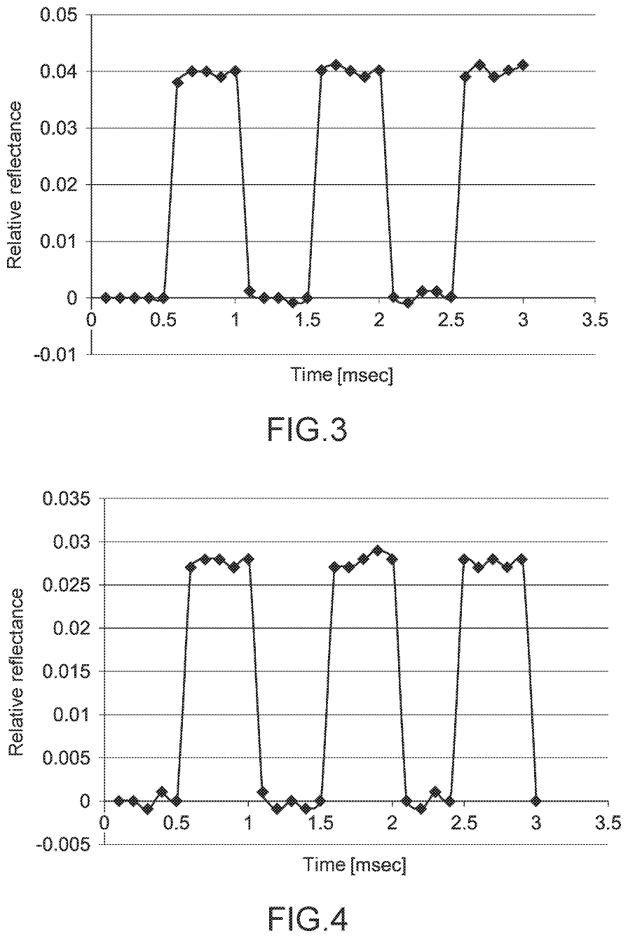

FIG. 3 is a graph showing a time response of the reflectance at this time. A relative reflectance of the longitudinal axis shows a reflectance normalized by the reflectance when no voltage is applied. At the time of applying 0 V, there is no change in the reflectivity, but at the time of applying 75 V, a reflectivity is about 4% higher.

Incidentally, when using a laser light source having a wavelength different from this wavelength by 50 nm, the modulation width of the reflectance was extremely small, the change was about 0.04% even at maximum.

Next, the sine waves of 55 V and 0 V were applied to the optical element at the frequency of 1 kHz, and laser light was irradiated using a semiconductor laser FPL1040S (oscillation wavelength of 1940 nm, manufactured by Thorlabs Corporation).

FIG. 4 is a graph showing a time response of a reflectance at this time. A relative reflectance of the longitudinal axis shows a reflectance normalized by the reflectance when no voltage is applied. At the time of applying 0 V, there is no change in the reflectivity, but at the time of applying 55 V, a reflectivity is about 2.8% higher.

As described above, the optical element according to the example can change the wavelength to be modulated by the applied voltage, and the wavelength to be modulated is limited to a narrow band. That is, the optical element can control the wavelength of the modulation target with high accuracy by the applied voltage.

The present technology may also have the following structures.

(1)

An optical element, including:

a first conductor film having light transmittance and capable of controlling optical transition energy by a Fermi level adjustment;

a second conductor film having the light transmittance and capable of controlling the optical transition energy by the Fermi level adjustment; and

a dielectric film arranged between the first conductor film and the second conductor film and having the light transmittance and elasticity.

(2)

The optical element according to (1), in which

the dielectric film is formed of a material having a relative dielectric constant of 1.8 or more and 100 or less and a tensile modulus of 3000 MPa or less.

(3)

The optical element according to (2), in which

the dielectric film is formed of a material having a tensile modulus of 10 MPa or more and 900 MPa or less.

(4)

The optical element according to (3), in which

the dielectric film is formed of a material having a tensile modulus of elasticity of 200 MPa or less.

(5)

The optical element according to (1), in which the dielectric film is formed of a material having an elongation value of 100% or more and 800% or less by an elongation test prescribed in an ASTM D638 standard.

(6)

The optical element according to (1), in which the dielectric film is formed of a material having a compressive strength value of 500 kg/cm² or more by a compressive strength test prescribed in an ASTM D695 standard.

(7)

The optical element according to (3), in which the dielectric film is formed of an elastomer, rubber, low density polyethylene, tetrafluoroethylene, silicone, cellulose acetate or an ethylene-vinyl acetate copolymer.

(8)

The optical element according to any one of (1) to (7), in which the dielectric film has a thickness of 100 nm or more and 10 mm or less.

(9)

The optical element according to any one of (1) to (7), in which the first conductor film and the second conductor film each has a light absorption coefficient that changes by increasing or decreasing a carrier concentration.

(10)

The optical element according to any one of (1) to (9), in which the first conductor film and the second conductor film have elasticity.

(11)

The optical element according to (9), in which each of the first conductor film and the second conductor film is formed of graphite, carbon nanotube, nanographite, fullerenes, a carbon fiber, or a carbon black.

(12)

The optical element according to any one of (1) to (11), further including:

a light reflection film having a light reflectivity arranged on a side opposite to the dielectric film of the first conductor film.

(13)

The optical element according to (12), in which

the light reflection film has elasticity.

(14)

The optical element according to (13), in which

the light reflection film is formed of gold, silver, copper, aluminum, nickel or a titanium compound.

(15)

The optical element according to any one of (1) to (14), in which

the first conductor film and the second conductor film are connected to a power source for applying a potential difference between the first conductor film and the second conductor film, and

when the potential difference is applied between the first conductor film and the second conductor film, the dielectric film is pressed from the first conductor film and the second conductor film by an electrostatic attraction force generated between the first conductor film and the second conductor film to cause elastic deformation so that a film thickness is changed.

(16)

An electronic apparatus, including:

an optical element including a first conductor film having light transmittance and capable of controlling optical transition energy by a Fermi level adjustment, a second conductor film having the light transmittance and capable of controlling the optical transition energy by the Fermi level adjustment, and a dielectric film arranged between the first conductor film and the second conductor film and having the light transmittance and elasticity.

### REFERENCE SIGNS LIST

100 optical element
101 base material
102 light reflection film
103 first conductor film
104 second conductor film
105 dielectric film

1. An optical element, comprising:
a first conductor film having light transmittance and capable of controlling optical transition energy by a Fermi level adjustment;
a second conductor film having the light transmittance and capable of controlling the optical transition energy by the Fermi level adjustment; and
a dielectric film arranged between the first conductor film and the second conductor film and having the light transmittance and elasticity.

2. The optical element according to claim 1, wherein
the dielectric film is formed of a material having a relative dielectric constant of 1.8 or more and 100 or less and a tensile modulus of 3000 MPa or less.

3. The optical element according to claim 2, wherein
the dielectric film is formed of a material having a tensile modulus of 10 MPa or more and 900 MPa or less.

4. The optical element according to claim 3, wherein
the dielectric film is formed of a material having a tensile modulus of elasticity of 200 MPa or less.

5. The optical element according to claim 1, wherein
the dielectric film is formed of a material having an elongation value of 100% or more and 800% or less by an elongation test prescribed in an ASTM D638 standard.

6. The optical element according to claim 1, wherein
the dielectric film is formed of a material having a compressive strength value of 500 kg/cm² or more by a compressive strength test prescribed in an ASTM D695 standard.

7. The optical element according to claim 3, wherein
the dielectric film is formed of an elastomer, rubber, low density polyethylene, tetrafluoroethylene, silicone, cellulose acetate or an ethylene-vinyl acetate copolymer.

8. The optical element according to claim 1, wherein
the dielectric film has a thickness of 100 nm or more and 10 mm or less.

9. The optical element according to claim 1, wherein
the first conductor film and the second conductor film each has a light absorption coefficient that changes by increasing or decreasing a carrier concentration.

10. The optical element according to claim 1, wherein
the first conductor film and the second conductor film have elasticity.

11. The optical element according to claim 10, wherein
each of the first conductor film and the second conductor film is formed of graphite, carbon nanotube, nanographite, fullerenes, a carbon fiber, or a carbon black.

12. The optical element according to claim 1, further comprising:
a light reflection film having a light reflectivity arranged on a side opposite to the dielectric film of the first conductor film.

13. The optical element according to claim 12, wherein
the light reflection film has elasticity.

14. The optical element according to claim 13, wherein
the light reflection film is formed of gold, silver, copper, aluminum, nickel or a titanium compound.

15. The optical element according to claim 1, wherein
the first conductor film and the second conductor film are connected to a power source for applying a potential difference between the first conductor film and the second conductor film, and
when the potential difference is applied between the first conductor film and the second conductor film, the dielectric film is pressed from the first conductor film and the second conductor film by an electrostatic attraction force generated between the first conductor film and the second conductor film to cause elastic deformation so that a film thickness is changed.

16. An electronic apparatus, comprising:
an optical element including a first conductor film having light transmittance and capable of controlling optical transition energy by a Fermi level adjustment, a second conductor film having the light transmittance and capable of controlling the optical transition energy by the Fermi level adjustment, and a dielectric film arranged between the first conductor film and the second conductor film and having the light transmittance and elasticity.
